(19) United States
(12) Patent Application Publication
(10) Pub. No.: US 2025/0299861 A1
(43) Pub. Date: Sep. 25, 2025

(54) ELECTROMAGNETIC ENGINE

(71) Applicants: Reshma N Kheraj, Dunwoody, GA (US); Naresh Pulipati, Dunwoody, GA (US)

(72) Inventors: Reshma N Kheraj, Dunwoody, GA (US); Naresh Pulipati, Dunwoody, GA (US)

(21) Appl. No.: 19/084,169

(22) Filed: Mar. 19, 2025

Related U.S. Application Data
(60) Provisional application No. 63/567,916, filed on Mar. 20, 2024.

(51) Int. Cl. H01F 7/02; H01F 7/16

(52) U.S. Cl. CPC H01F 7/0231; H01F 7/16

(57) ABSTRACT

An electromagnetic engine for use in vehicles, generators, and the like. The electromagnetic engine includes a cylinder disposed within the housing of the engine. The electromagnetic engine further includes a piston having a piston head, the piston head moves within the cylinder in a back-and-forth motion. A first magnet is coupled to the piston head and a second magnet is coupled to the cylinder or the housing, wherein at least one of the first magnet and the second magnet is an electromagnet. The first magnet and/or the second magnet, which is the electromagnet, is coupled to the control unit. The control unit can drive the piston through electromagnetic forces between the first magnet and the second magnet.

### CROSS REFERENCE TO RELATED APPLICATIONS

This application claims priority from a U.S. Provisional Patent Appl. No. 63/567,916, filed on Mar. 20, 2024, which is incorporated herein by reference in its entirety.

### FIELD OF INVENTION

The present invention relates to an electromagnetic engine, and more particularly, the present invention relates to an electromagnetic engine that uses alternative magnetic poles to drive a piston.

### BACKGROUND

Internal combustion engines typically operate on the principle of converting the chemical energy of fuel into mechanical energy. In an internal combustion engine, fuel is burned in a chamber, and the resulting hot gases drive a piston in a back-and-forth motion. This motion is then converted into rotary or linear motion by a crankshaft and a set of gears. Internal combustion engines are widely used worldwide in automobiles, electricity generators, and similar applications.

There is a prevalent use of internal combustion engines, however, the burning of petroleum-based fuels has presented a significant challenge. The escalating fuel prices and the rapid acceleration of global warming have sparked serious concerns about the use of these fuels. There is an urgent need to innovate new types of fuels to power the engines.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to the use of electromagnetic forces for driving the engines.

Another object of the present invention is that the engine does not produce any exhaust gases.

Still, another object of the present invention is that engine noise can be significantly reduced.

Yet another object of the present invention is that the efficiency of the engine can be significantly enhanced.

A further object of the present invention is that the speed of the engine can be increased and decreased very quickly.

In one aspect, disclosed is an electromagnetic engine comprising a cylinder disposed within a housing of the electromagnetic engine, the cylinder having a proximal end and a distal end; a piston having a piston head, the piston head configured to move within the cylinder in a back-and-forth motion, the piston has a proximal end and a distal end, the piston head is at the proximal end of the piston; a first magnet coupled to the piston head; a second magnet coupled to the cylinder or the housing, wherein at least one of the first magnet and the second magnet is an electromagnet; and a control unit, wherein the electromagnet is coupled to the control unit, wherein the control unit is configured to drive the piston through electromagnetic forces between the first magnet and the second magnet.

In one aspect, the second magnet is the electromagnet, wherein the control unit is configured to charge the second magnet at a predefined frequency in a pulsed manner, wherein a polarity of the second magnet is the same as that of the first magnet causing movement of the first magnet away from the second magnet.

In one aspect, the second magnet is the electromagnet, wherein the control unit is configured to charge the second magnet at a predefined frequency in an alternate polarity and a polarity of the first magnet remains the same.

In one aspect, disclosed is a method for driving an electromagnetic engine, the electromagnetic engine comprises a cylinder disposed within a housing of the electromagnetic engine, the cylinder having a proximal end and a distal end; and a piston having a piston head, the piston head configured to move within the cylinder in a back-and-forth motion, the piston has a proximal end and a distal end, the piston head is at the proximal end of the piston. The method comprises coupling a first magnet to the piston head; coupling a second magnet to the cylinder or the housing, wherein at least one of the first magnet and the second magnet is an electromagnet; and coupling the electromagnet to a control unit, wherein the control unit is configured to drive the piston through electromagnetic forces between the first magnet and the second magnet.

In one aspect, the second magnet is the electromagnet, wherein the method comprises charging, by the control unit, the second magnet at a predefined frequency in a pulsed manner, wherein a polarity of the second magnet is the same as that of the first magnet causing the movement of the first magnet away from the second magnet.

In one aspect, the second magnet is the electromagnet, wherein the method further comprises charging, by the control unit, the second magnet at a predefined frequency in an alternate polarity, wherein a polarity of the first magnet remains the same.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating an electromagnetic mechanism for an electromagnetic engine, according to an exemplary embodiment of the present invention.

FIG. 2 illustrates major parts of the electromagnetic engine, according to an exemplary embodiment of the present invention.

FIG. 3 is a block diagram showing a variation in the electromagnetic device for driving the engine, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including” when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is an electromagnetic device for driving engines. Also, disclosed is an electromagnetic engine that is driven by electromagnetic forces. The disclosed engine does not use any fuel but is based on electromagnetic forces to drive the piston of the engine. The engine may include a piston and crankshaft, similar to a conventional engine, however, injectors and combustion chambers are eliminated, which makes the disclosed engine more compact in construction. The engine, according to the present invention, could be more easily assembled and installed, bringing down the manufacturing cost. The maintenance cost of these engines can also be significantly reduced.

The disclosed electromagnetic engine uses alternating magnetic poles of a movable magnet against a fixed magnet to generate “to & fro”, “pulsating”, “vibratory”, or “Oscillatory” movement of the piston. The engine uses at least one movable magnet which can be an electromagnet or a permanent magnet. The engine further uses at least one fixed magnet which can also be an electromagnet or a permanent magnet, provided that at least one of the fixed and movable magnets is an electromagnet. Also, both the fixed magnet and movable magnet can be electromagnets. The engine may also include a control unit that operates at least one fixed magnet and at least one movable magnet. A power source, such as a battery, can power the electromagnets and the control unit.

The engine includes a cylinder within which a piston head can move back and forth. The cylinder and the piston head are within the housing of the engine. The cylinder may have a proximal end and a distal end. The piston may have a proximal end and a distal end. The piston head can be at the proximal end of the piston while the distal end of the piston i.e., a piston rod can be coupled to a shaft for transferring the motion of the piston. The proximal end of the piston and the proximal end of the housing may lie at the same end.

The piston head may include the movable magnet. The magnet can be suitably packed in the piston head to prevent any physical damage to the magnet. For example, the packing can protect from any impact caused by the piston head coming in contact with the cylinder. To protect the components against moisture, water, dust, and the like, the housing of the engine can be sealed. Also, it is to be noted that multiple units of magnets can form the movable magnet in the piston head. The movable magnet can be an electromagnet or a permanent magnet. In case, the movable magnet is an electromagnet, the movable magnet can also be connected to the control unit and the power source. Also, multiple movable magnets can be coupled to different areas of the piston. For example, other movable magnets can be coupled to the distal end of the piston or at the middle of the piston.

The fixed magnet can be disposed at the proximal end of the cylinder so that the magnetic fields of the movable magnet and the fixed magnet have the maximum overlap, and some suitable distance is always there between the two magnets. The fixed magnet can be a permanent magnet or an electromagnet. In the case of the electromagnet, the fixed magnet can be coupled to the control unit and the power source. As described above, at least one of the movable and fixed magnets is an electromagnet, and both the movable and fixed magnets can be electromagnets. Also, it is to be noted that more than one fixed magnet can be disposed on the cylinder, for example at the proximal and distal ends of the cylinder. Also, the position of the fixed magnet can vary relative to the movable magnets without departing from the scope of the present invention.

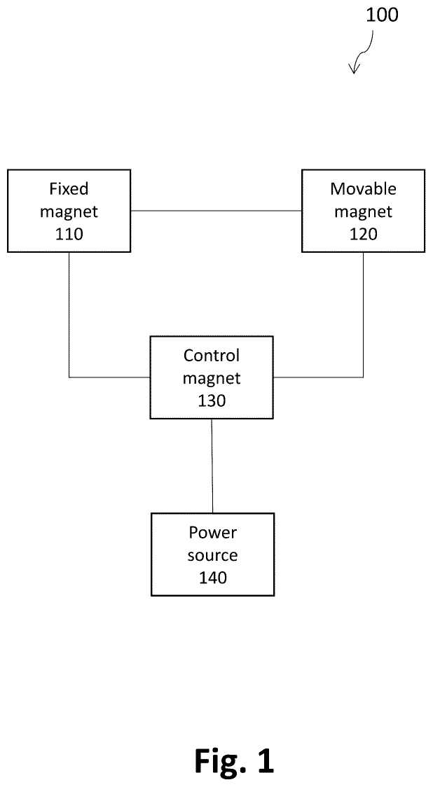

Refer to FIG. 1 which is a block diagram showing an exemplary embodiment of the disclosed electromagnetic mechanism and a device based on the electromagnetic mechanism for use in engines. The electromagnetic mechanism and the device include a fixed magnet 110, a movable magnet 120, a control unit 130, and a power source 140. The electromagnets and the power source can be connected to the control unit. Also, the control unit can be connected to the transmission and controllers of the apparatus containing the disclosed engine. Also, disclosed is an apparatus, such as a vehicle or electricity generator containing the disclosed engine.

In certain implementations, the electromagnets can be packed into suitable insulative materials to prevent any short circuit. The disclosed control unit can be connected to controllers of the appartus for receiving various controls signals, such as turning the engine on and off, changing the speed, and the like. Also, the control unit can send information such as the rpm of the engine, temperature, and the like. The control unit can be connected to the other controllers through a wired connection or a wireless connection. Suitable sensors can also be deployed in the engine to detect various parameters, such as rpm, movement of the piston, condition of the electromagnets, and the like. The data provided by these sensors can be used for general information in the operation of the engine and for diagnosing the engine for any troubleshooting.

The control unit can charge the electromagnet(s) so that repulsive electromagnetic forces are created between the fixed and movable magnets, which causes the movable magnet to move away from the fixed magnet. The electromagnet(s) can be charged in pluses i.e., on-state and off-state with a suitable duration, also referred to herein as the frequency. During the on-state, the movable magnet is repelled away from the fixed magnet towards the distal end of the cylinder, and the movement of the piston is transferred to the shaft. In the off state, the movable magnet can return to the proximal end of the cylinder, close to the fixed magnet. In the off state, the movement of the shaft itself can cause the piston to move back. In case, the movable magnet is a permanent magnet, the attractive magnetic forces can cause the piston to move towards the fixed magnet. Such attractive forces are also possible when the movable magnet is an electromagnet, and the fixed magnet is a permanent magnet.

Instead of the pulsed charging of electromagnet(s) at a predefined frequency, the electromagnet(s) can also be charged alternatively between the attractive polarity and repulsive polarity at a predetermined frequency. For example, the movable magnet is repelled in the repulsive polarity state and is attracted towards the fixed magnet in the attractive polarity state. The use of alternating polarity can impart more torque to the shaft.

The power source can be a battery, such as rechargeable batteries. The power source can also be any renewable source of energy, such as electricity from a solar panel. The power source can be a part of the device, such as a portable power generator containing a battery.

The power source can also be separated from the device, such as the battery system in an electric vehicle. Any kind of power source is within the scope of the present invention.

Also, the control unit can

[symbol]

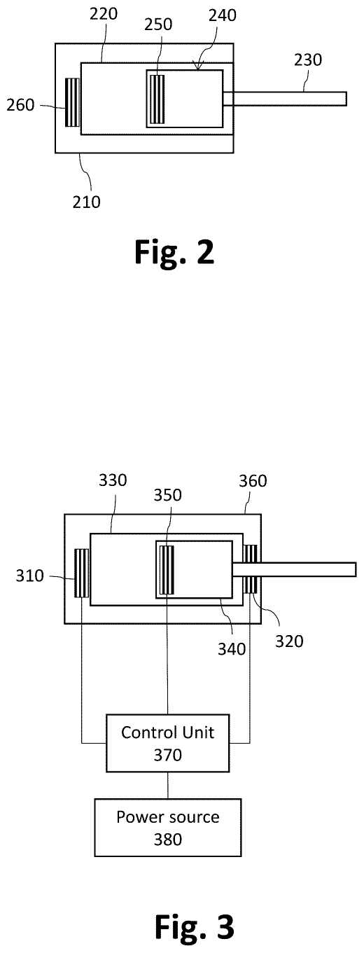

Referring to FIG. 2, shows housing 210, a cylinder 220 within the housing 210, and a piston 230 having a piston head 240 encased within the cylinder 220. A movable magnet 250 can be built into the piston head 240. Fixed magnet 260 can be configured in starting or near the cylinder 220.

Referring to FIG. 3 shows another implementation of the disclosed device in which two fixed magnets drive one movable magnet. The fixed magnets can preferably be electromagnets, however, the fixed magnets can also be permanent magnets, provided that at least the movable magnet or fixed magnets are electromagnets. The movable magnet can be an electromagnet or permanent magnet.

The movable magnet can be coupled to a piston, such as the piston head of the piston. It is to be noted that more than one magnet unit can form a movable magnet. Also, more than one movable magnet can be coupled to the piston at one or different positions, and any such variations are within the scope of the present invention. One of the two fixed magnets can be coupled at the proximal end of the cylinder and the other fixed magnet can be configured at the distal end of the cylinder. The control unit can charge the two fixed magnets using pulsed frequency, i.e., an on-state and an off-state separated by a predefined duration. When the first fixed magnet is in the on-state, it repels the piston head i.e., the movable magnet towards the second fixed magnet which is in the off-state. When the movable magnet reaches close enough to the second fixed magnet, the second fixed magnet is turned on and the first fixed magnet is turned off. This causes the movable magnet to reverse direction and move towards the first fixed magnet. This cycle can be repeated to generate the continuous to-and-fro motion of the piston. FIG. 3 shows a first fixed electromagnet 310 and a second fixed electromagnet 320 disposed at the ends of a cylinder 330 encasing a piston head 340, and the piston head including a movable magnet 350, and a housing 360 encasing different components. A control unit 370 is also shown that can be coupled with electromagnets and a power source 380. Also, it is obvious that when the movable magnet is an electromagnet, it is also charged by the control unit according to the polarity of the fixed magnets. Also, FIG. 1 and FIG. 3 show general features of the invention without any limitation, and some features described in FIG. 1 may not be repeated for FIG. 3, and vice versa. Also, in certain implementations, the casing of electromagnets can attract other magnets even when they are in off state.

Also, above is described that one or more fixed electromagnets are charged by the control unit in a pulsed manner or alternating poles, however, the fixed electromagnet can remain turned on in either one of two polarities. The movable magnet which is an electromagnet can be turned on by the control unit in either a pulsed manner or alternate pole manner for the to-and-fro movement of the movable magnet. Also, one or two or more flexed electromagnets can be permanent magnets, and the movable magnet can be electromagnet which can be charged by the control unit for creating magnetic fields.

It is to be noted that the term “charging” the electromagnets herein means supplying current to the electromagnets till they reach a desired magnetic field strength, the desired magnetic field strength may or may not be the maximum magnetic field strength. Also, the term “charging” the electromagnets is synonymously used with “turning on” the electromagnets.

The control unit can manipulate the speed, force & power of the engine by increasing or decreasing the electric current intensity of electromagnets, thus varying the magnetic field strength of the electromagnets producing variable power output.

The control unit can be controlled remotely using various types of communication channels/protocols including the Internet, Wi-Fi, and other known technologies to operate the engine. The control unit may not need to be pressed/operated manually, it can be controlled remotely using a remote controller or a computing device over a wired or wireless network. The control unit may also have GPS tagging capabilities to track the location of the engine. The control unit can also feed audio & video of the surroundings for various purposes. The control unit can be used to manipulate/adjust/operate other functions using computer programs/technologies remotely or by self-decision-making software/technologies for vehicles, machinery, etc. The control unit of this device can also be programmed to make self-decisions using technologies like Artificial Intelligence (AI) or any other computer programs or any other compatible technologies.

The disclosed device can be installed on all types of manned/unmanned/self-driving/self-flying/self-propelling vehicles in the air, on land & water like military tanks, ground vehicles, machinery, trains, fighter jets, helicopters, choppers, naval ships, drones, RC based Robots & vehicles, submarines, Government, private & public sector vehicles, etc. This device can also be used for domestic public safety & armed surveillance for all sectors.

This device offers minimal vibrations as the movable and fixed magnets are contactless while generating power output and stable along the axis of motion. The disclosed engine can be connected to other compatible components to deliver power output in many ways, such as connecting to a gearbox, etc.

In certain implementations, the engine can have multiple cylinders, and each cylinder has a magnetic piston and fixed magnets. For example, the piston can be a movable electromagnet and the top of the cylinder contains a fixed electromagnet or permanent magnet, as the control unit magnetizes both electromagnets and controls the magnetic poles of the piston, alternating each time between attraction and repulsion making the piston move up and down, and in turn, a crankshaft connected to a piston rod, generates the mechanical power output. The power to the control unit can be provided by the main battery/power source. The alternator connected to the engine in turn can generate power and store the same in one or more batteries. The control unit can manage the main battery and other batteries to best utilize the power. This electromagnetic engine will be easy to retrofit into any vehicle.

In another aspect, the electro-mechanical components in combination with magnetic or without magnetic components can be used to generate all possible motion (to & fro, pulsating, vibratory, Oscillatory, or the like motion/energy/power) that can be operated manually or remotely using all compatible technologies, methods, principles, software, etc.

The novel principle used in this Engine/Mechanism can be used for any general purpose to achieve the desired mechanical/electric/electromagnetic power or output. The electromagnetic engine is noncombustible, generates green energy/power, and is cleaner for the environment.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An electromagnetic engine comprising:
a cylinder disposed within a housing of the electromagnetic engine, the cylinder having a proximal end and a distal end;
a piston having a piston head, the piston head configured to move within the cylinder in a back-and-forth motion, the piston has a proximal end and a distal end, the piston head is at the proximal end of the piston;
a first magnet coupled to the piston head;
a second magnet coupled to the cylinder or the housing, wherein at least one of the first magnet and the second magnet is an electromagnet; and
a control unit, wherein the electromagnet is coupled to the control unit, wherein the control unit is configured to drive the piston through electromagnetic forces between the first magnet and the second magnet.

2. The electromagnetic engine of claim 1, wherein the second magnet is the electromagnet, wherein the control unit is configured to charge the second magnet at a predefined frequency in a pulsed manner, wherein a polarity of the second magnet is the same as that of the first magnet causing movement of the first magnet away from the second magnet.

3. The electromagnetic engine of claim 1, wherein the second magnet is the electromagnet, wherein the control unit is configured to charge the second magnet at a predefined frequency in an alternate polarity and a polarity of the first magnet remains the same.

4. The electromagnetic engine of claim 2, wherein the first magnet is a permanent magnet.

5. The electromagnetic engine of claim 3, wherein the first magnet is a permanent magnet.

6. The electromagnetic engine of claim 2, wherein the first magnet is an electromagnet.

7. The electromagnetic engine of claim 3, wherein the first magnet is an electromagnet.

8. A method for driving an electromagnetic engine, the electromagnetic engine comprising:
a cylinder disposed within a housing of the electromagnetic engine, the cylinder having a proximal end and a distal end; and
a piston having a piston head, the piston head configured to move within the cylinder in a back-and-forth motion, the piston has a proximal end and a distal end, the piston head is at the proximal end of the piston,
wherein the method comprises:
coupling a first magnet to the piston head;
coupling a second magnet to the cylinder or the housing, wherein at least one of the first magnet and the second magnet is an electromagnet; and
coupling the electromagnet to a control unit, wherein the control unit is configured to drive the piston through electromagnetic forces between the first magnet and the second magnet.

9. The method of claim 8, wherein the second magnet is the electromagnet, wherein the method comprises:
charging, by the control unit, the second magnet at a predefined frequency in a pulsed manner, wherein a polarity of the second magnet is the same as that of the first magnet causing the movement of the first magnet away from the second magnet.

10. The method of claim 8, wherein the second magnet is the electromagnet, wherein the method further comprises:
charging, by the control unit, the second magnet at a predefined frequency in an alternate polarity, wherein a polarity of the first magnet remains the same.

11. The method of claim 9, wherein the first magnet is a permanent magnet.

12. The method of claim 10, wherein the first magnet is a permanent magnet.

13. The method of claim 9, wherein the first magnet is an electromagnet.

14. The method of claim 10, wherein the first magnet is an electromagnet.
